(19) United States
(12) Patent Application Publication
(10) Pub. No.: US 2007/0264391 A1
(43) Pub. Date: Nov. 15, 2007

(54) Enzymatic Process for Preparing Pacha Taint Free Tea

(76) Inventors: Nagalakshmi Sreekantayya, Mysore (IN); Lingamallu Jagan Mohan Rao, Mysore (IN); Chandrasekhar Nanjundaswamy, Mysore (IN); Ramaswamy Shanmughasundaram Senthil Kumar, Valparai (IN)

Correspondence Address: LADAS & PARRY, 26 WEST 61ST STREET, NEW YORK, NY, 10023, US

(21) Appl. No.: 10/582,891

(22) PCT Filed: Dec. 31, 2003
(86) PCT No.: PCT/IN03/00428

§ 371 Date: Feb. 28, 2007

(51) Int. Cl. A23F 3/10

(52) U.S. Cl. 426/52

(57) ABSTRACT

The present invention provides an enzymatic process for the prevention of development of pacha taint in CTC tea which comprises: (I) mixing an enzyme in water to form an enzyme solution; (II) spraying the enzyme solution homogeneously on rolled and distorted tea leafy material used in the black tea manufacturing process; (III) fermenting the enzyme solution sprayed rolled and distorted tea leafy material obtained at the end of step (II) (iv) drying the fermented material obtained in step (III). The enzyme can be mixture of any of lipase, lipoxygenase anel alcoholdehydrogenase.

### FIELD OF THE INVENTION

The present invention provides a process for the preparation of pacha taint free tea. In particular, the invention provides a process using enzymes to prevent formation of pacha taint in CTC (Crush Tear Curl) tea.

### BACKGROUND OF THE INVENTION

Tea is one of the most popular and earliest known beverages across the world. Tea refers to the plant Camellia sinenesis; the dried, processed leaf manufactured from it, extracts derived from the leaf, and beverages prepared from the leaf or extracts of this species. The development of the most characteristic attributes of the tea, i.e. the flavour and colour of the beverage is dependent on the manipulation of tealeaves to induce certain biochemical changes (Scott, 1964, Biotechnology, 5; 577). The starting material for manufacturing tea consists of tender young shoots, usually two or three leaves and the bud of the tea plant. The chemical composition of these shoots and the reactions that occur during the process determine the nature of the finished product.

During the processing and then storing, certain off flavours along with desired flavours develop in the tea. ‘Green note’ is one such flavour. This off flavour which is developed in storage after three to four weeks from manufacture is also called ‘grassy’, ‘fishy’ or ‘painty’ flavour and commonly known as ‘pacha taint’ (Ganeshan and Ramaswamy, 1996, February, The Planters Chronicle, p 91)

This type of off-flavour was reported in the Wynaad and Nilgiri-Wynaad regions of India during certain periods of the year in CTC teas after 3-6 weeks of storage. When the teas were fresh, professional tasters report these as normal. Pacha taint has become a serious concern for planters and traders of tea in the Wynaad and Nilgiri-Wynaad areas of India. The price of pacha-tainted tea is low when compared to normal tea. Due to this problem, the product prices are less than compared to normal tea. Thus there is an urgent need to prevent this problem of development of pacha taint.

This taint or off flavour is increasingly becoming a menace in tea industry. This taint occurs mainly during the storage after the manufacturing is accomplished. The chemical constituents mainly responsible for the formation of this odour/taint are C₆ aldehydes and C₆ alcohols. These compounds are formed when the lipid degradation followed by fatty acid oxidation takes place. The lipids not degraded during the manufacturing process due to the less activity of respective enzymes and degrade during storage and off flavour is produced. Several other factors enhance the development of grassy odour in tea, such as low temperature of firing, increased plucking intervals, type and period of withering, rolling, fermentation etc. Various environmental conditions also have a role to develop this taint.

Deterioration of food with time results largely from its biological nature and is inevitable. During production, processing, distribution and storage prior to actual consumption, food undergoes various modes of deterioration that involve biological changes by microbes as well as chemical changes. The latter is ascribed to enzymatic and non-enzymatic oxidation of lipids and phenolic substance, which cause undesirable changes in flavour, appearance, physical character, nutritional value and toxicity. Deoxygenation, airtight packing, and other techniques have solved some of these problems to a certain extent. However, the addition of enzymes could be helpful to compensate the low activity of in situ enzymes during certain seasons.

Literature survey revealed that there is no report on the prevention of the development of off-flavour in tea.

### OBJECTS OF THE INVENTION

The main object of the present invention is to provide a process for the prevention of development of pacha taint in CTC teas using enzymes.

### SUMMARY OF THE INVENTION

Accordingly the present invention provides an enzymatic process for the prevention of development of pacha taint in CTC tea which comprises:
(i) mixing an enzyme in water to form an enzyme solution;
(ii) spraying the enzyme solution homogeneously on rolled and distorted tea leafy material used in the black tea manufacturing process;
(iii) fermenting the enzyme solution sprayed rolled and distorted tea leafy material obtained at the end of step (ii)
(iv) drying the fermented material obtained in step (iii).

In one embodiment of the invention, the enzyme solution prepared in step (i) comprises a mixture of enzymes, which are suitable for lipid degradation.

In another embodiment of the invention the step (ii) is carried out at a spray rate of one litre of solution in 5-8 minutes.

In yet another embodiment of the invention fermentation in step (iii) is carried out while maintaining a temperature in the range of 25-30° C. and while mixing the tea material thoroughly.

In yet another embodiment of the invention, the tea material is dried in step (iv) using a Fludised Bed Dryer and at a temperature in the range of 130-140° C.

In yet another embodiment of the invention, the enzyme used in step (i) comprises a mixture of any of lipase, lipoxygenase, alcholdehydrogenase and materials containing the enzymes in optimized quantities selected from yeast and enzymes from soy bean.

### DETAILED DESCRIPTION OF THE INVENTION

The present invention provides a process for the prevention of development of pacha taint in CTC teas using enzymes. The process comprises preparing an enzyme solution in water or any appropriate solvent and spraying the enzyme solution homogeneously on the rolled and distorted tea leafy material in the black tea manufacturing process. This material is then fermented and then dried and packed suitable. The packed material is stored and then tasted by professional and qualified tasters to determine the level at which the development of pacha taste is prevented.

The enzymes used are a mixture of lipid degrading enzymes such as lipase, lipoxygenase and alcholdehydrogenase/materials containing the enzymes in optimized quantities selected from the group of yeast, enzymes from soy bean. Spraying is preferably done at a spray rate of spray one litre of solution in 5-8 minutes. Subsequently fermentation is carried out in a fermentor while maintaining the temperature in the range of 25-30° C. and while mixing the tea material thoroughly. The dryer used for drying the fermented material is a Fluidised bed dryer, which could bemused at 130-140° C. The dried material is packed in polythene covers/gunny bags with polythene thin film layer inside it. Storage of the packed material is carried out at ambient conditions such as at 25-30° C.

A process for the prevention of development of pacha taint in CTC teas using enzymes carried out according to following scheme.

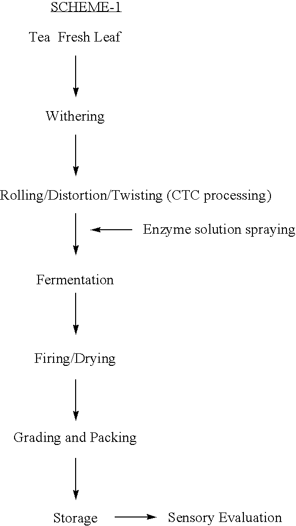

Sensory evaluation: Appearance of the product is observed. 3 g of Super Fine Dust (SFD) is brewed in 142 ml of boiling water for 5 min. The colour, aroma and taste of the brew are scored on a ten-point scale. The colour, aroma and flavour of the infusion are also scored on a ten-point scale. Taster's remarks are presented.

The advantages of the process are:

This is the first report of a process for the prevention of development of pacha taint in CTC teas using enzymes.

The novelty of the process resides in the use of mixture of enzymes for the prevention of development of pacha taint in CTC teas.

### EXAMPLE-1

Tealeaves (1500 g) withered for 18 h. Leaves were subjected to distortion using rotarvane and CTC machine. Twisted leaf is mixed with reconstituted tea material. Enzyme solution is sprayed manually onto the rolled/distorted tealeaf material and subjected to fermentation at 27° C. for 60 min. Fermented leaves were subjected to drying in a Fluidised bed dryer at 135° C. for 12, minutes until the moisture is reduced to 3%. Super fine dust is packed separately and kept for storage and then subjected to sensory evaluation at two weeks interval up to twelve weeks. The scores are presented in the following table.

### EXAMPLE-2

Tealeaves (500 Kg) withered for 20 h. Leaves were subjected to distortion using one rotarvane and four CTC machines in series. Reconstituted tea material is mixed with leaf during distortion. Enzyme solution is sprayed using power sprayer onto the rolled/distorted tealeaf material and subjected to fermentation at 27° C. for 60 min in drums under special conditions. Fermented leafy material was subjected to drying in a Fluidized bed dryer at 135° C. for 12 minutes until the moisture is reduced to 3%. Super fine dust is packed separately and kept for storage. It was subjected to sensory evaluation at two weeks interval for three months. The scores are presented in the following table.

TABLE 1
CHEMICAL PARAMETES OF SFD SAMPLES FROM
NILGIRI-WYNAD REGION: FACTORY TRIALS

| | | | | Leaf | | |
|---|---|---|---|---|---|---|
| | | Leaf | | aldehyde | | Taster's |
| | Lipid | aldehyde | Lipid (%) | (μg %) | Taster's | Score |
| | (%) | (μg %) | (After 4 | (After 4 | Score | after 4 |
| Samples | (Initial) | (Initial) | weeks) | weeks) | Initial | weeks |
| T2 - Control | 7.43 | 2070 | 6.48 | 1778 | 8 | 4 |
| T4 - Enzyme combination | 7.20 | 1513 | 6.00 | 1190 | 7 | 7 |
| T7 - Enzyme Combination | 7.25 | 1399 | 6.81 | 1076 | 7 | 7 |
| T8 -Control | 7.43 | 2070 | 6.93 | 1886 | 8 | 4 |

After 4 weeks the taster's score remained unaltered, indicating the samples remained good.

We claim:

1. An enzymatic process for the prevention of development of pacha taint in CTC tea which comprises:
(i) mixing the enzyme in a solvent to form an enzyme solution;
(ii) spraying the enzyme solution homogeneously on rolled and distorted tea leafy material used in the black tea manufacturing process;
(iii) fermenting the enzyme solution sprayed rolled and distorted tea leafy material obtained at the end of step (ii)
(iv) drying the fermented material obtained in step (iii).

2. A process as claimed in claim 1 wherein the enzyme solution prepared in step (i) comprises a mixture of enzymes, which are suitable for lipid degradation.

3. A process as claimed in claim 1 wherein step (ii) is carried out at a spray rate of one litre of solution in 5-8 minutes.

4. A process as claimed in claim 1 wherein the fermentation in step (iii) is carried out while maintaining a temperature in the range of 25-30° C. and while mixing the tea material thoroughly.

5. A process as claimed in claim 1 wherein the tea material is dried in step (iv) using a Fludised Bed Dryer and at a temperature in the range of 130-140° C.

6. A process as claimed in claim 1 wherein the enzyme used in step (i) comprises a mixture of any of lipase, lipoxygenase, alcholdehydrogenase and materials containing the enzymes in optimized quantities selected from yeast and enzymes from soy bean.

7. A process as claimed in claim 1 wherein the solvent is water.
